(19) United States
(12) Patent Application Publication
(10) Pub. No.: US 2025/0233359 A1
(43) Pub. Date: Jul. 17, 2025

(54) CONNECTOR

(71) Applicant: SUMITOMO WIRING SYSTEMS, LTD., Mie (JP)

(72) Inventor: Kazuo NAKAI, Mie (JP)

(21) Appl. No.: 18/730,799

(22) PCT Filed: Jan. 10, 2023
(86) PCT No.: PCT/JP2023/000264

§ 371 Date: Jul. 22, 2024

(30) Foreign Application Priority Data
Jan. 24, 2022 (JP) 2022-008662

(51) Int. Cl. H01R 13/639; H01R 13/502; H01R 107/00

(52) U.S. Cl. CPC H01R 13/639; H01R 13/502; H01R 2107/00

(57) ABSTRACT

A second housing includes a receptacle serving as a housing body and a lock portion projecting on an upper surface of the housing body. The first housing includes a base portion and a lock body portion extending from the base portion and deflectable and deformable with the base portion as a fulcrum. The lock portion has a locking surface facing in a direction opposite to a connection direction of the second housing to the first housing. The lock body portion includes a locking portion on a tip part in an extension direction from the base portion, the locking portion facing the locking surface and being lockable to the locking surface. A rotation center part is set above a lock peak serving as an uppermost part of the locking surface of the lock portion.

### TECHNICAL FIELD

The present disclosure relates to a connector.

### BACKGROUND

Patent Document 1 discloses male and female connectors connectable to each other. The female connector is provided with a housing body and a receptacle surrounding the outer periphery of the housing body. A deflectable and deformable lock arm is coupled to the receptacle. The male connector is provided with a fitting tube portion fittable into the receptacle and a lock protrusion projecting on the upper surface of the fitting tube portion. The male and female connectors are held in a connected state by locking the lock arm to the lock protrusion. Connectors provided with a locking structure of this type are also disclosed in Patent Documents 2 and 3.

### PRIOR ART DOCUMENT

### Patent Document

Patent Document 1: JP 2002-329554 A
Patent Document 2: JP 2013-004376 A
Patent Document 3: JP 2013-243008 A

### SUMMARY OF THE INVENTION

### Problems to be Solved

In the case of Patent Document 1, the female connector is moved forward and connected to the male connector, and the lock arm is formed to project forward from a fulcrum portion for a deflection movement. A front end part of the lock arm rides on the lock protrusion in the process of connecting the male and female connectors and, thereafter, rides over the lock protrusion. Immediately before the connection of the male and female connectors is completed, the front end part of the lock arm is displaced along an arcuate rotation path from the upper end of the lock protrusion toward a front lower side (rotation path in a direction from 12 o'clock to 9 o'clock when the lock arm is deflected and deformed counterclockwise on a clock face at the time of being locked to the lock protrusion), and becomes lockable to the lock protrusion. However, if the front end part of the lock arm is displaced along the above rotation path, there is a concern that the male and female connectors in the connected state rattle more or less.

Accordingly, the present disclosure aims to provide a connector capable of suppressing rattling.

### Means to Solve the Problem

The present disclosure is directed to a connector with a first housing and a second housing connectable to each other, the second housing including a housing body and a lock portion projecting on an upper surface of the housing body, the first housing including a base portion and a lock body portion extending from the base portion, the lock body portion being deflectable and deformable with the base portion as a fulcrum, the lock portion having a locking surface facing in a direction opposite to a connection direction of the second housing to the first housing, the lock body portion including a locking portion on a tip part in an extension direction from the base portion, the locking portion being arcuately displaced about a rotation center part on the base portion side, the locking portion facing and being lockable to the locking surface, and the rotation center part being set above an uppermost part of the locking surface of the lock portion in a connected state of the first and second housings.

### Effect of the Invention

According to the present disclosure, it is possible to provide a connector capable of suppressing rattling.

### BRIEF DESCRIPTION OF THE DRAWINGS

FIG. 1 is a section showing a case where a first housing and a second housing are in a connected state in a connector according to a first embodiment.

FIG. 2 is an enlarged section of an essential part of a locking structure of FIG. 1.

FIG. 3 is a section, corresponding to FIG. 2, of the locking structure immediately before a connecting operation of the first and second housings is completed.

FIG. 4 is a plan view showing the case where the first and second housings are in the connected state.

FIG. 5 is a plan view of the first housing having a part corresponding to a covering portion cut off.

FIG. 6 is a front view of the first housing.

FIG. 7 is a back view of the first housing.

FIG. 8 is a perspective view of a first connector.

FIG. 9 is an enlarged section of an essential part extracting and showing the locking structure at the time of separating the first and second housings.

FIG. 10 is a view, corresponding to FIG. 4, of a connector according to a second embodiment.

FIG. 11 is a view, corresponding to FIG. 8, of the second embodiment.

### DETAILED DESCRIPTION TO EXECUTE THE INVENTION

### Description of Embodiments of Present Disclosure

First, embodiments of the present disclosure are listed and described.

(1) The connector of the present disclosure is provided with a first housing and a second housing connectable to each other, the second housing including a housing body and a lock portion projecting on an upper surface of the housing body, the first housing including a base portion and a lock body portion extending from the base portion, the lock body portion being deflectable and deformable with the base portion as a fulcrum, the lock portion having a locking surface facing in a direction opposite to a connection direction of the second housing to the first housing, the lock body portion including a locking portion on a tip part in an extension direction from the base portion, the locking portion being arcuately displaced about a rotation center part on the base portion side, the locking portion facing and being lockable to the locking surface, and the rotation center part being set above an uppermost part of the locking surface of the lock portion in a connected state of the first and second housings.

If it is assumed that the first housing moves forward and is connected to the second housing and the lock body portion is shaped to extend forward from the base portion when the connection direction of the first housing to the second housing is a forward direction, the locking portion can be displaced along an arcuate rotation path from a front upper side toward a rear lower side (rotation path in a direction from 9 o'clock to 6 o'clock if the lock body portion is deflected and deformed counterclockwise on a clock face when being locked to the lock portion) according to the above configuration. Then, a state where the locking portion can contact the locking surface of the lock portion is easily realized and rattling between the first and second housings can be suppressed as compared to the case where the locking portion is displaced along an arcuate rotation path from a rear upper side toward a front lower side (rotation path in a direction from 12 o'clock to 9 o'clock on the clock face).

(2) Preferably, the locking portion has a locked surface inclined in a direction separating from the locking surface from a locking part for contacting a lowermost part of the locking surface of the lock portion toward an upper side in the connected state of the first and second housings.

Since the locking portion can tightly contact the lowermost part of the locking surface without contacting the uppermost part of the locking surface in the above configuration, a locked state of the locking portion and the lock portion can be firmly maintained.

(3) The first housing may include an extending portion extending side by side with the lock body portion from the base portion and a wall portion coupled to a tip part of the extending portion in the extension direction from the base portion, the extending portion may be deflectable and deformable with the wall portion as a fulcrum, and the base portion may be displaceable in a vertical direction according to a deflection movement of the extending portion.

Since the base portion can be flexibly displaced when the lock body portion interferes with the lock portion in the above configuration, the locking portion can be prevented from being accidentally displaced to the rear lower side.

Further, stress concentration only on the base portion can be avoided when the lock body portion interferes with the lock portion. As a result, the breakage and the like of the base portion can be prevented even if the first housing is structured not to sufficiently ensure toughness.

(4) A pair of the extending portions and a pair of the wall portions may be provided on both sides across the lock body portion, and the pair of wall portions may be arranged to cover the lock body portion from the both sides.

In the above configuration, the wall portions can have a function of protecting the lock body portion in addition to a function of serving as fulcrums of the extending portions.

(5) The pair of wall portions may include front portions for covering the tip part of the lock body portion in the extension direction from the base portion, rear portions for covering the base portion from the both sides and bent portions extending in a direction separating from the lock body portion from the front portions to the rear portions, a releasing operation space for releasing locking of the lock body portion with the lock portion may be formed between a pair of the rear portions, and tip parts of the extending portion in the extension direction from the base portion may be coupled to the bent portions.

In the above configuration, the locked state of the lock portion and the lock body portion can be released by pressing the base portion by inserting a finger or the like into the releasing operation space. Particularly, since the extending portions are coupled to the bent portions for forming the releasing operation space, the releasing operation space, the wall portions, the extending portions, the base portion and the lock body portion can be arranged with good space efficiency in the first housing and the enlargement of the first housing can be avoided.

### Details of Embodiments of Present Disclosure

Specific examples of embodiments of the present disclosure are described below with reference to the drawings. Note that the present invention is not limited to these illustrations, but is represented by claims and intended to include all changes in the scope of claims and in the meaning and scope of equivalents.

### First Embodiment

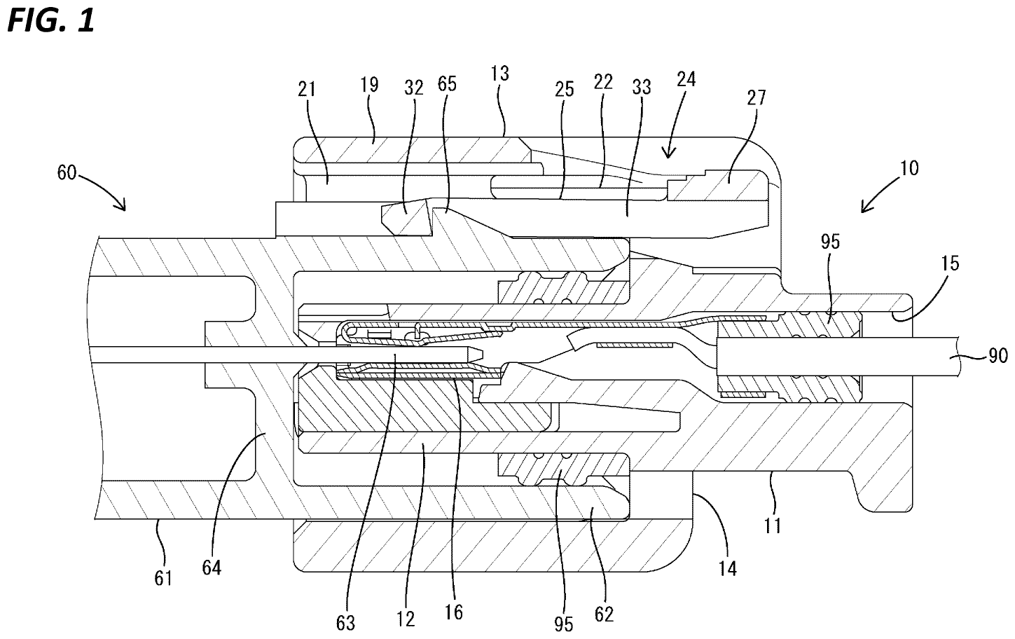

A connector according to a first embodiment of the present disclosure is, as shown in FIG. 1, composed of a first connector 10 and a second connector 60. The first connector 10 is illustrated as a female connector. The second connector 60 is illustrated as a male connector. The first connector 10 is provided with a first housing 11. The second connector 60 is provided with a second housing 61 connectable to the first housing 11. Note that, in the following description, surface sides facing each other when the connection of the first and second connectors 10, 60 is started are referred to as front sides concerning a front-rear direction. A vertical direction is based on a vertical direction of FIG. 1. The vertical direction is not necessarily limited to a vertical direction (direction of gravity) when the connector is installed in a vehicle or the like. A lateral direction is a direction orthogonal to the front-rear direction and vertical direction, and synonymous with a width direction.

### (Second Housing)

The second housing 61 is made of synthetic resin and directly coupled to an unillustrated device. The second housing 61 includes a receptacle 62 (housing body) in the form of a flat tube long in the width direction. As shown in FIG. 1, a plurality of second terminal fittings 63 (only one is shown in FIG. 1) are arranged to project into the receptacle 62. The respective second terminal fittings 63 are mounted side by side in the width direction through a back wall 64 of the receptacle 62, although not shown. Each second terminal fitting 63 is a pin-like or tab-like male terminal fitting. A rear end part of each second terminal fitting 63 is soldered and connected to an unillustrated circuit board.

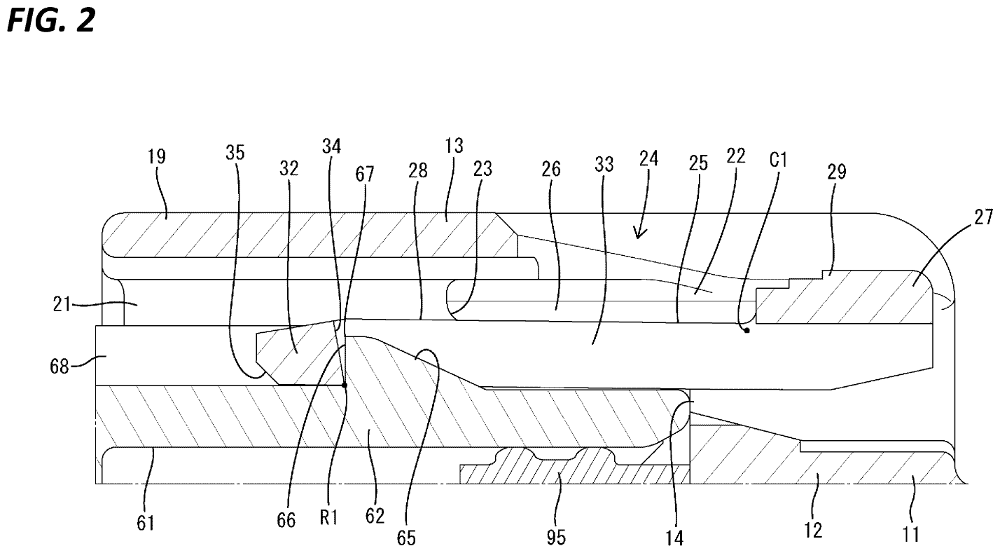

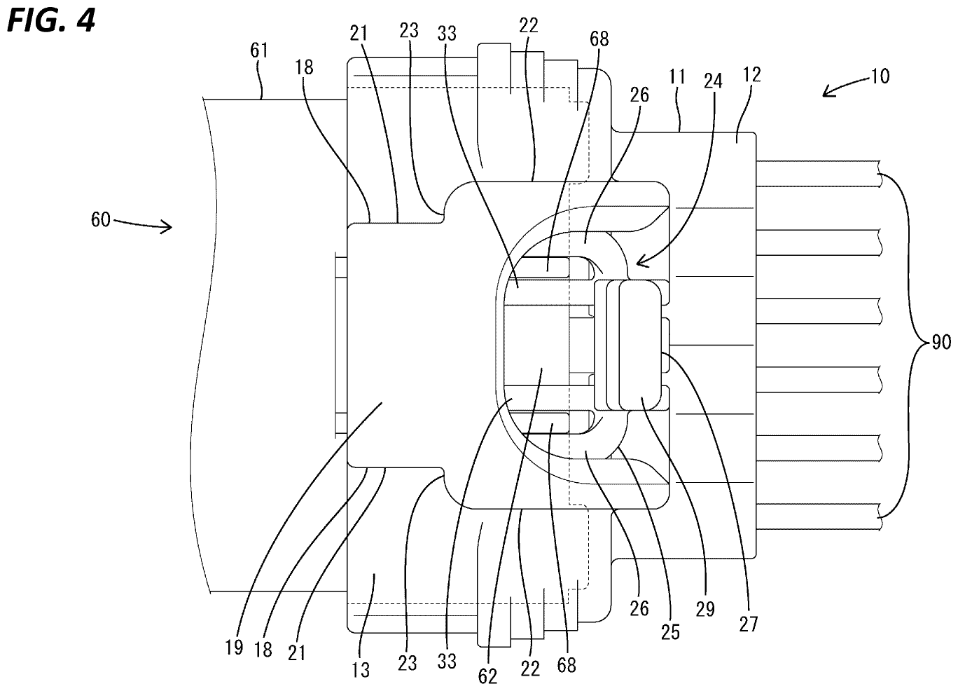

A lock portion 65 projects on the upper surface of the upper wall of the receptacle 62. The front surface of the lock portion 65 is formed into a slope shape inclined gently rearward toward an upper side. The upper surface of the lock portion 65 is horizontally arranged in the front-rear direction. The rear surface of the lock portion 65 is perpendicularly arranged along the vertical direction. As shown in FIG. 2, the rear surface of the lock portion 65 serves as a locking surface 66 facing a locking portion 32 to be described later. Further, the lock portion 65 includes a lock peak 67 on a corner part where the locking surface 66 and the upper surface intersect. The lock peak 67 is located on an uppermost part of the lock portion 65. A pair of guide portions 68 (see FIG. 4) are formed on both left and right sides across the lock portion 65 on the upper surface of the upper wall of the receptacle 62. Each guide portion 68 is in the form of a rib extending in the front-rear direction on the upper surface of the upper wall.

### (First Housing)

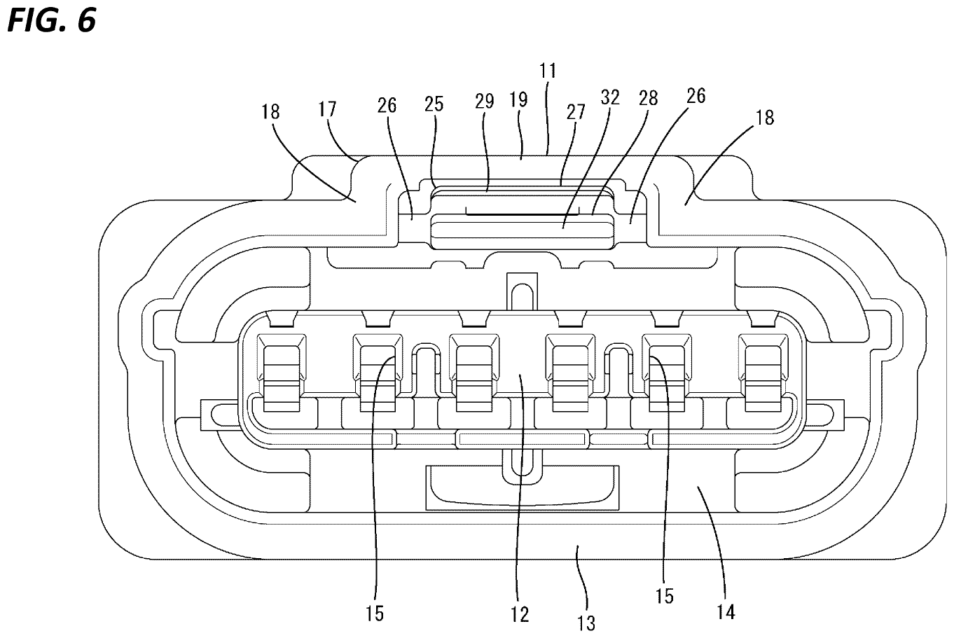

The first housing 11 is made of synthetic resin and includes, as shown in FIGS. 6 to 8, a terminal accommodating portion 12 long in the width direction and a fitting tube portion 13 in the form of a flat tube surrounding the outer periphery of the terminal accommodating portion 12. A rear end part of the fitting tube portion 13 and the terminal accommodating portion 12 are coupled via a linking portion 14. The first housing 11 contains a reinforcing material such as a glass filler to suppress sliding wear between the first housing 11 and first terminal fittings 16 to be described later during vibration.

The terminal accommodating portion 12 includes a plurality of cavities 15. The respective cavities 15 are arranged side by side in the width direction in the terminal accommodating portion 12. As shown in FIG. 1, the first terminal fitting 16 is inserted and accommodated into each cavity 15 from behind. The first terminal fitting 16 is a female terminal fitting, into which the second terminal fitting 63 is inserted to be connected, when the first and second housings 11, 61 are connected.

A rear end part of the first terminal fitting 16 is crimped and connected to an end part of a wire 90. A rubber plug 95 to be held in close contact with the inner peripheral surface of the cavity 15 is fit on the outer peripheral surface of the wire 90. A sealing ring 96 is fit on the outer peripheral surface of the terminal accommodating portion 12. When the first and second housings 11, 61 are in a connected state, the sealing ring 96 is arranged in a state resiliently compressed between the receptacle 62 and the terminal accommodating portion 12. In this way, the first and second housings 11, 61 are maintained liquid-tight.

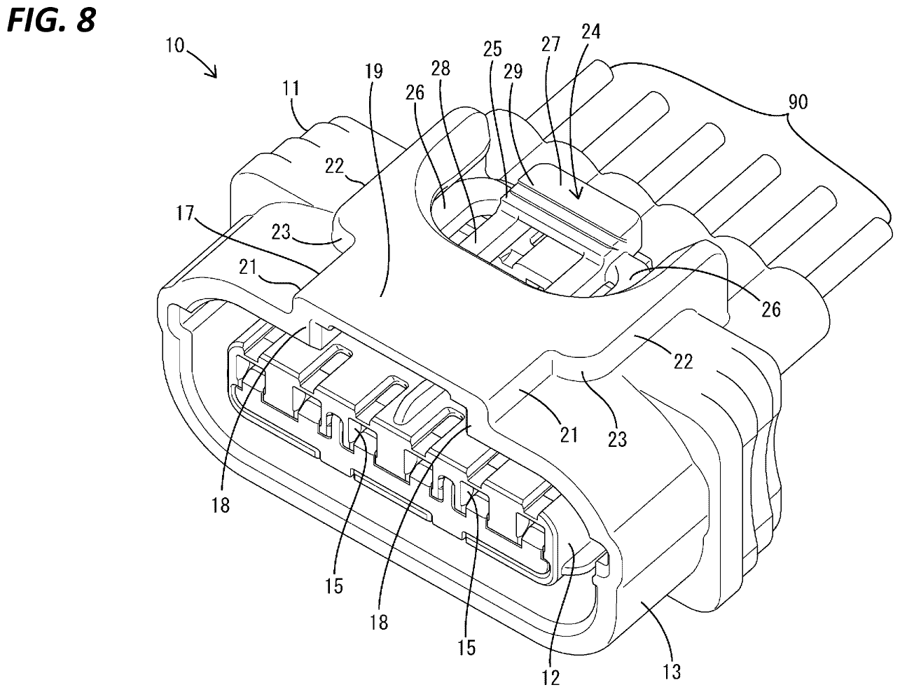

As shown in FIG. 8, the fitting tube portion 13 includes a bulging portion 17 flatly bulging upward in a widthwise central part of the upper wall. The bulging portion 17 includes a pair of wall portions 18 facing each other while being spaced apart in the width direction and a covering portion 19 for covering the terminal accommodating portion 12 from above between the respective wall portions 18. Each wall portion 18 is arranged along the vertical direction. Each wall portion 18 is rib-like and includes, as shown in FIGS. 4 and 8, a pair of front portions 21 extending in the front-rear direction on a front end side of the fitting tube portion 13, a pair of rear portions 22 extending in the front-rear direction while being wider spaced apart than the respective front portions 21 on a rear end side of the fitting tube portion 13, and a pair of bent portions 23 extending outward in the width direction from the respective front portions 21 to the respective rear portions 22.

The covering portion 19 is bridged between the upper ends of the respective wall portions 18. The covering portion 19 is flatly arranged in the front-rear direction and lateral direction. The fitting tube portion 13 forms a releasing operation space 24 behind the covering portion 19 and between the respective rear portions 22. The rear end of the covering portion 19 defines the releasing operation space into an arc shape. The releasing operation space 24 serves as a space for allowing the entrance of a worker's finger in pressing a base portion 27 to be described later.

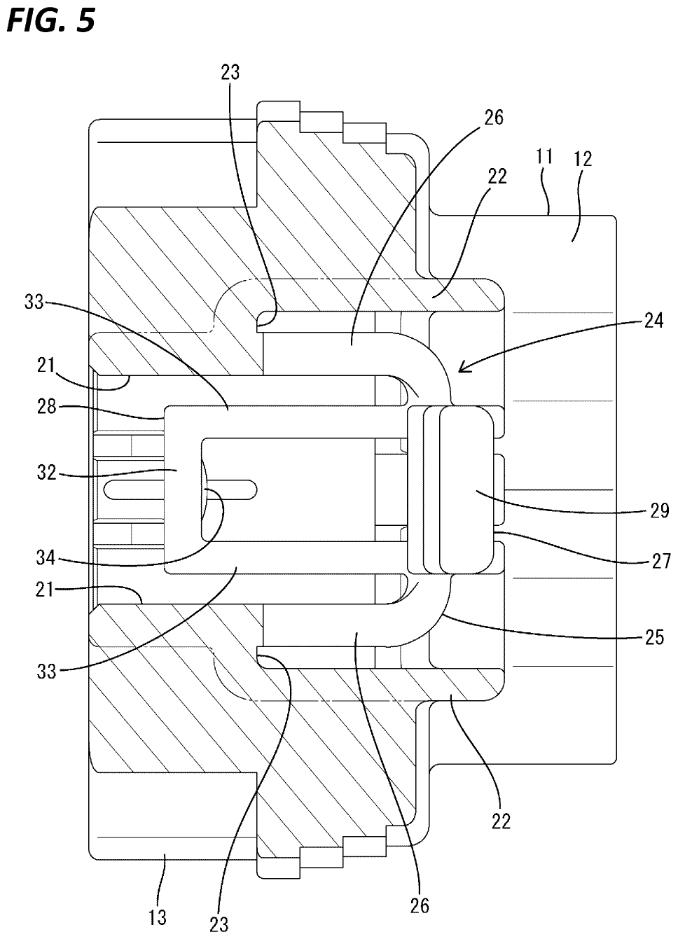

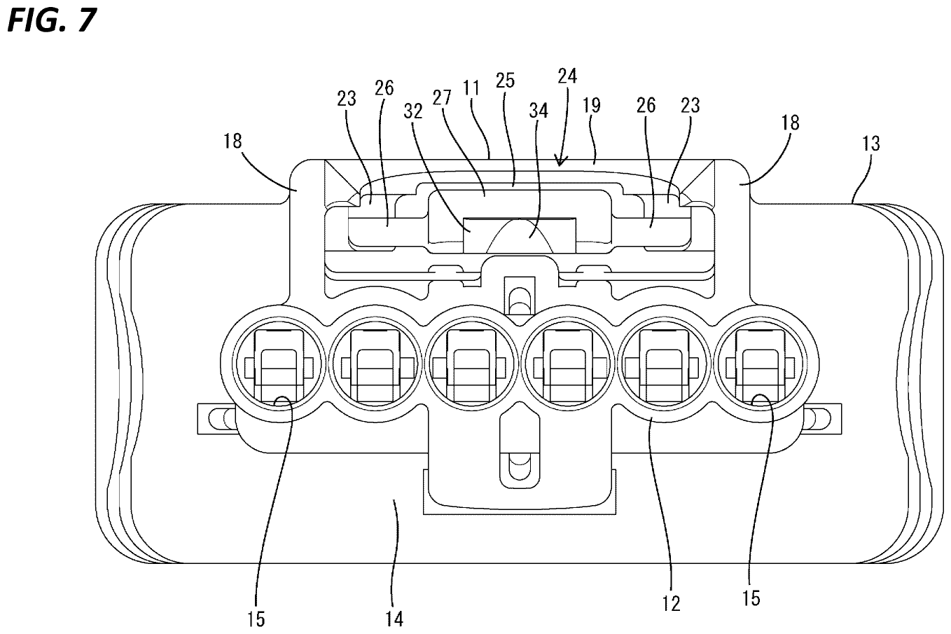

The first housing 11 includes a lock arm 25. As shown in FIG. 5, the lock arm 25 is composed of a pair of extending portions 26 extending rearward from the respective bent portions 23, the base portion 27 bridged between the rear ends of the respective extending portions 26 in the width direction and a lock body portion 28 projecting forward from a widthwise central part of the base portion 27. As shown in FIGS. 6 and 7, the lock arm 25 is arranged between the terminal accommodating portion 12 and the covering portion 19 in the vertical direction, and not coupled to the terminal accommodating portion 12.

As shown in FIG. 5, each extending portion 26 is strip-like and the plate surfaces thereof are facing in the vertical direction. Each extending portion 26 is deflectable and deformable in the vertical direction with the bent portion 23 as a fulcrum. Each extending portion 26 is horizontally arranged in the front-rear direction in a natural state (see FIG. 2).

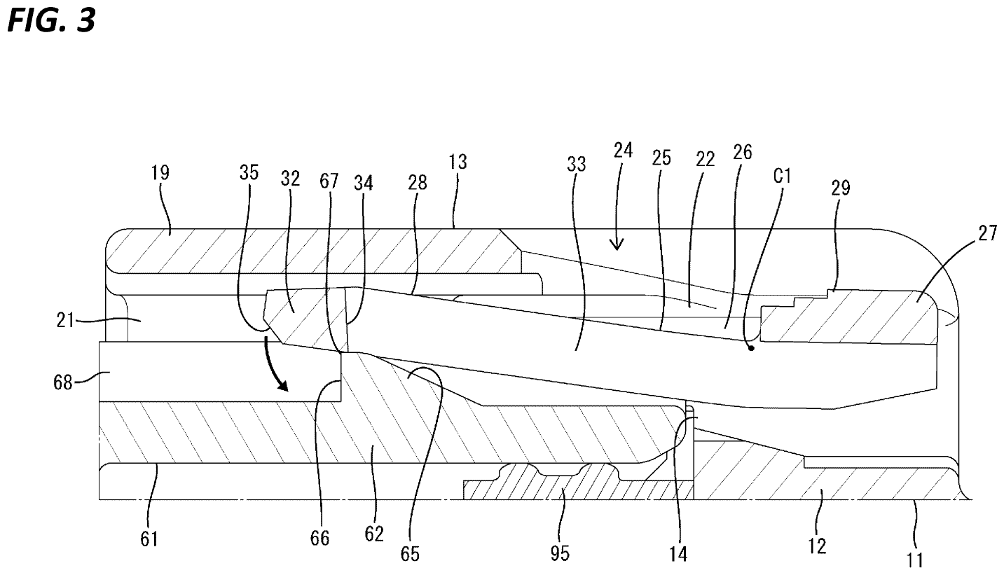

Rear end parts of the respective extending portions 26 are arcuately bent inward in the width direction and coupled to both widthwise ends of the base portion 27. The base portion 27 includes a releasing portion 29 at a position higher than the respective extending portions 26. The upper surface of the releasing portion 29 has a stepped shape gradually elevated toward the rear side. As shown in FIGS. 2 and 3, a rear end part of the lock arm 25 is formed with a rotation center portion C1 constituting a rotation center position of the lock body portion 28 to be described later. In the case of the first embodiment, the rotation center part C1 is an axis of rotation part extending in the width direction in an upper end part near the base portion 27 in each inner extending portion 33 to be described later.

As shown in FIG. 5, the lock body portion 28 is in the form of a rectangular frame and the plate surfaces thereof are facing in the vertical direction. The lock body portion 28 includes the locking portion 32 extending in the width direction on a front end side and a pair of the inner extending portions 33 extending rearward from both widthwise ends of the locking portion 32. The rear ends of the respective inner extending portions 33 are respectively coupled to both widthwise end parts of the releasing portion 29 of the base portion 27. The respective inner extending portions 33 are arranged in parallel to and side by side with the respective extending portions 26 inside the respective extending portions 26 in the width direction. A width of each inner extending portion 33 is smaller than that of each extending portion 26.

The lock body portion 28 is deflectable and deformable in the vertical direction with the base portion 27 as a fulcrum. The locking portion 32 is displaceable along an arcuate rotation path about the rotation center part C1.

When the lock body portion 28 is in a natural state, the upper surface of the locking portion 32 is inclined downward toward the front, and the rear surface (surface facing toward the base portion 27) of the locking portion 32 has a part inclined upward as shown in FIG. 2. Specifically, the rear surface of the locking portion 32 has a locked surface 34 inclined rearward from an upper end to a lower end. The locked surface 34 of the locking portion 32 arcuately projects rearward in a plan view (see FIG. 5) in a widthwise central part of the rear surface of the locking portion 32, is arcuately widened downward in a back view (see FIG. 7) and has a convex arc shape when viewed from behind. When the first and second housings 11, 61 are in the connected state, the locked surface 34 of the locking portion 32 is arranged to face and be lockable to the locking surface 66 of the lock portion 65. Further, the front surface of the locking portion 32 has a front inclined surface 35 inclined downward on a lower end part.

### (Connector Connection Method and Connection Structure)

The first and second housings 11, 61 are brought closer and connected from a state squarely facing each other. The respective guide portions 68 enter between the extending portions 26 and the inner extending portions 33 while extending along the corresponding front portions 21 (see FIG. 4) and guide a deflection movement of the lock arm 25 to be described later. In the process of connecting the first and second housings 11, 61, the front inclined surface 35 of the locking portion 32 slides on the front surface (front surface when viewed from the second housing 61) of the lock portion 65 and the lock body portion 28 is deflected and deformed with the base portion 27 as a fulcrum. Simultaneously, each extending portion 26 is deflected and deformed with the wall portion 18 as a fulcrum. The locking portion 32 rides on the lock portion 65 and is displaced upward, and the base portion 27 is displaced to somewhat sink downward by the inclination of each extending portion 26 (see FIG. 3).

Immediately before the connecting operation of the first and second housings 11, 61 is completed, the locking portion 32 rides over the lock portion 65 and is separated from the lock peak 67. Here, as shown in FIG. 3, the rotation center part C1 is located above the height position of the lock peak 67 of the lock portion 65 (also the height position of the upper surface of the lock portion 65). Thus, by further connecting the first and second housings 11, 61, the locking portion 32 is displaced from a front upper side where the lock peak 67 is located (front upper side when viewed from the first housing 11) toward a rear lower side (rear lower side when viewed from the first housing 11), i.e. along a rotation path (see an arrow of FIG. 3) in a counterclockwise direction from 9 o'clock to 6 o'clock on a clock face, about the rotation center part C1 according to a resilient restoring force of the lock body portion 28.

If the first and second housings 11, 61 reach a proper connection position, the tip of the receptacle 62 butts against the linking portion 14 and any further connecting operation of the first and second housings 11, 61 is stopped (see FIG. 2). At this time, the lock portion 65 enters a space between the respective inner extending portions 33 behind (behind when viewed from the first housing 11) the locking portion 32. The locking portion 32 contacts the upper surface of the upper wall of the receptacle 62. A lowermost part of the locked surface 34 of the locking portion 32 contacts a lowermost part of the locking surface 66 of the lock portion 65 (hereinafter, this position is referred to as a “locking part R1” (see FIG. 2)). The locking portion 32 is obliquely arranged to be gradually separated from the locking surface 66 of the lock portion 65 from the locking part R1 (position for contacting the lowermost part of the locking surface 66 of the lock portion 65) toward an upper side.

In the first embodiment, the locking portion 32 is displaced along the rotation path in the direction from 9 o'clock to 6 o'clock (counterclockwise in the direction from 9 o'clock to 6 o'clock in clock positions), whereby a state where the locking portion 32 contacts the lowermost part of the locking surface 66 of the lock portion 65 can be realized in the process of connecting the first and second housings 11, 61. Thus, rattling between the first and second housings 11, 61 can be suppressed.

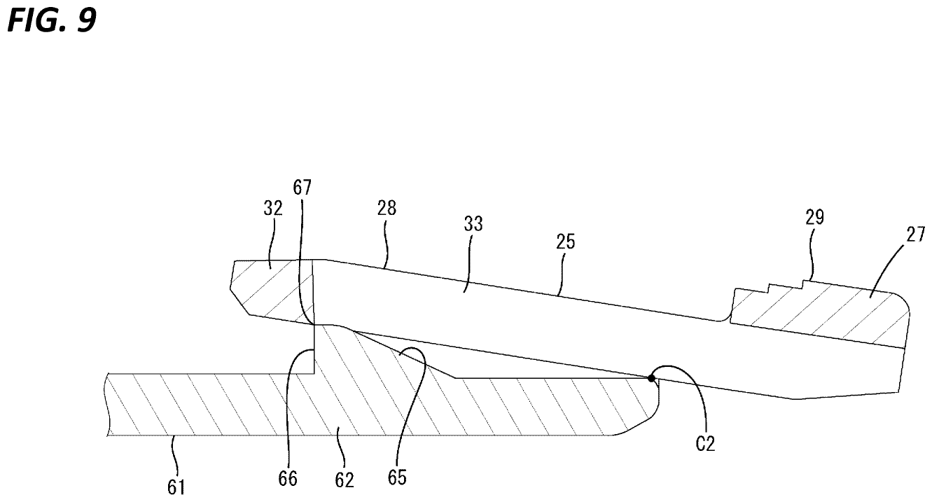

At the time of separating the connectors, a worker's finger is inserted into the releasing operation space 24 from above and the base portion 27 is displaced downward by being pressed by the finger. Then, as shown in FIG. 9, a lower end part of each inner extending portion 33 contacts a tip part of the receptacle 62, the locking portion 32 is rotated to be lifted up with that contact part C2 as a fulcrum, and the locking of the lock portion 65 and the lock body portion 28 is released. By pulling apart the first and second housings 11, 61 from that state, the first and second connectors 10, 60 can be separated from each other.

As described above, since the rotation center part C1 is set above the lock peak 67, which is an uppermost part of the locking surface 66 of the lock portion 65, according to the first embodiment, the rotation path of the locking portion 32 in the connection process can be directed in the direction from 9 o'clock to 6 o'clock shown by the arrow of FIG. 3. As a result, when the first and second housings 11, 61 are in the connected state, it is possible to realize a state where the locking portion 32 can contact the locking surface 66 of the lock portion 65 and to suppress rattling between the first and second housings 11, 61.

Further, the locked surface 34 of the locking portion 32 is inclined in a direction separating from the locking surface 66 from the locking part R1 for contacting the lowermost part of the locking surface 66 of the lock portion 65 toward the upper side. Thus, the locking portion 32 can tightly contact the lowermost part of the locking surface 66 without contacting the lock peak 67, and a locked state of the locking portion 32 and the lock portion 54 can be firmly maintained.

Further, since the base portion 27 is displaceable in the vertical direction according to a deflection movement of each extending direction 26, the base portion 27 can be flexibly displaced and the locking portion 32 can be prevented from being accidentally displaced to a rear lower side when the locking portion 32 interferes with the lock portion 65.

Further, since each extending direction 26 is deflected and deformed with each wall portion 18 as a fulcrum, the lock body portion 28 is deflected and deformed with the base portion 27 as a fulcrum and the base portion 27 is displaceable in the vertical direction, stress concentration only on the base portion 27 can be avoided when the lock body portion 28 interferes with the lock portion 65. As a result, the breakage and the like of the base portion 27 can be prevented even if sufficient toughness of the first housing 11 cannot be ensured.

Further, since the respective wall portions 18 are arranged to cover the lock body portion 28 from both sides, the respective wall portions 18 can have both a function of serving as fulcrums of the respective extending directions 26 and a function of protecting the lock body portion 28.

Further, since the releasing operation space 24 is formed between the respective rear portions 22 and each extending direction 26 is coupled to each bent portion 23 of the wall portion 18, the releasing operation space 24, the wall portions 18, the extending directions 26, the base portion 27 and the lock body portion 28 can be arranged with good space efficiency in the first housing 11 and the enlargement of the first housing 11 can be avoided.

### Second Embodiment

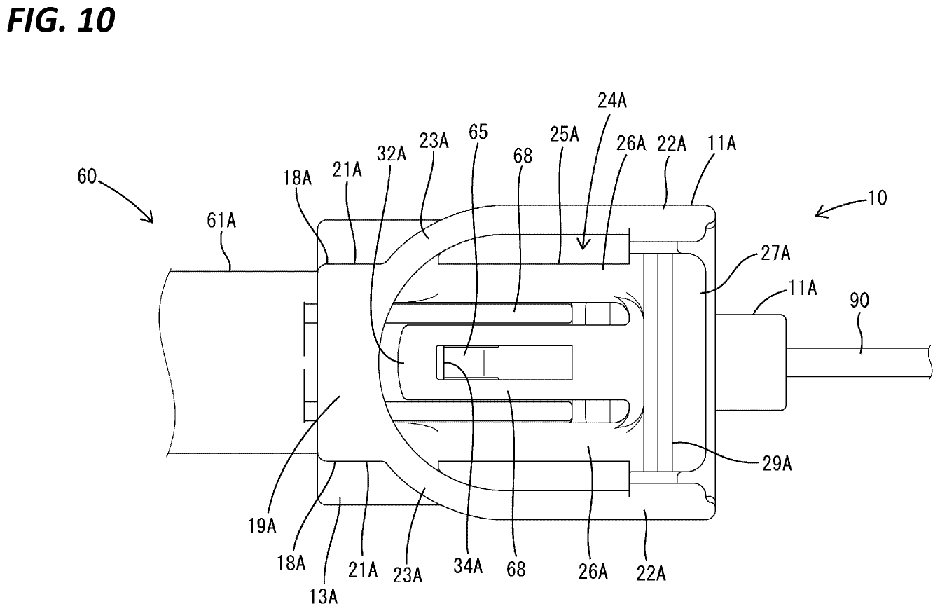

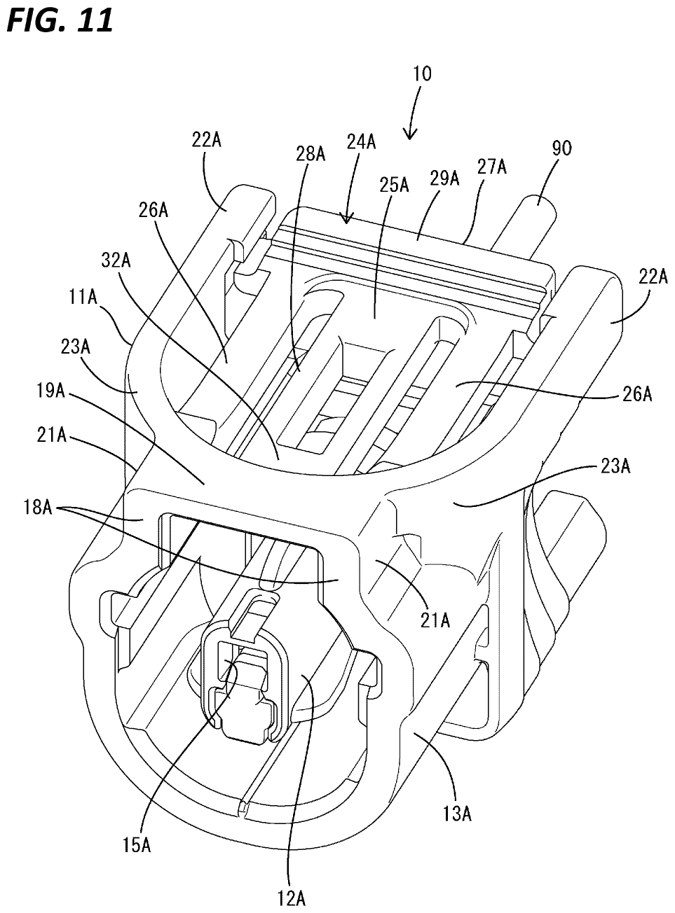

As shown in FIGS. 10 and 11, a first housing 11A for accommodating one unillustrated first terminal fitting 16 (similar to that of the first embodiment, see FIG. 1) is illustrated in a second embodiment of the present disclosure. One unillustrated second terminal fitting 63 (similar to that of the first embodiment, see FIG. 1) is mounted also in a second housing 61A as a connection partner of the first housing 11A. The first housing 11A of the second embodiment is configured similarly to that of the first embodiment, and includes a terminal accommodating portion 12A, a fitting tube portion 13A and a lock arm 25A.

As shown in FIG. 11, the terminal accommodating portion 12A includes one cavity 15A and is formed to be narrower than the terminal accommodating portion 12 of the first embodiment. The fitting tube portion 13A has a vertically long cross-sectional shape and is likewise formed to be narrower than the fitting tube portion 13 of the first embodiment.

Wall portions 18A provided in the fitting tube portion 13A include a pair of front portions 21A extending short in the front-rear direction, a pair of rear portions 22A extending long in the front-rear direction on both widthwise ends on a rear side of the fitting tube portion 13A and a pair of bent portions 23A curved and extending outward in the width direction from the front portions 21A to the rear portions 22A.

A releasing operation space 24A is largely cut into a U shape in a plan view between a covering portion 19A, the respective bent portions 23A and the respective rear portions 22A. As shown in FIG. 10, the entire lock arm 25A is visually confirmable from above through the releasing operation space 24A. Further, a locked state of a locking portion 32A and a lock portion 65 is also visually confirmable through the releasing operation space 24A.

A base portion 27A is shaped to extend long in the width direction. A releasing portion 29A stepped in an entire region in the width direction is formed on the upper surface of the base portion 27A. The rear ends of respective extending directions 26A are coupled to both widthwise end parts of the front surface of the base portion 27A.

The lock body portion 28A is formed to be narrower than the lock body portion 28 of the first embodiment. A locked surface 34A of the locking portion 32A is formed over the entire rear surface of the locking portion 32A. When the lock body portion 28A is in a natural state, the locked surface 34A of the locking portion 32A is inclined rearward from an uppermost part to a lowermost part as in the first embodiment. Unlike the first embodiment, the locked surface 34A of the locking portion 32A is arranged along the width direction in a plan view as shown in FIG. 10.

Also in the second embodiment, a rotation center part C1 is set above a lock peak 67 of the lock portion 65 as in the first embodiment although not shown in detail (see FIG. 2 of the first embodiment). Thus, a rotation path of the locking portion 32A in a connection process can be set in a direction from a front upper side (front upper side when viewed from the first housing 11A) to a rear lower side (front upper side when viewed from the first housing 11A) (direction from 9 o'clock to 6 o'clock). As a result, it is possible to realize a state where the locking portion 32A can contact a locking surface 66 of the lock portion 65 and suppress rattling between the first and second housings 11A, 61A.

### Other Embodiments of Present Disclosure

The embodiments disclosed this time should be considered illustrative in all aspects, rather than restrictive.

In the case of the first and second embodiments, the second connector is configured as a male connector including male terminal fitting(s) and the first connector is configured as a female connector including female terminal fitting(s). However, conversely, the second connector may be configured as a female connector including female terminal fitting(s) and the first connector may be configured as a male connector including male terminal fitting(s) as another embodiment.

In the case of the first and second embodiments, the base portion is coupled to each wall portion via each extending portion. However, as another embodiment, the base portion may be coupled to the terminal accommodating portion in a rising state.

In the case of the first and second embodiments, the locked surface of the lock portion is perpendicularly arranged along the vertical direction. However, as another embodiment, the locking surface of the lock portion may be arranged to be inclined rearward toward the upper side.

In the case of the first and second embodiments, the rotation center part is included in the base portion. However, as another embodiment, the rotation center part may be provided in the rear end part of the lock body portion near the base portion.

In the case of the first and second embodiments, the lock body portion is in the form of a frame rectangular in a plan view. However, as another embodiment, the lock body portion may be formed such that a locking portion projects downward from a columnar or plate-like lock part.

In the case of the first and second embodiments, the locked surface of the locking portion is inclined rearward from the uppermost part to the lowermost part when the lock body portion is in the natural state. However, as another embodiment, the locked surface of the locking portion may be perpendicularly arranged along the vertical direction when the lock body portion is in the natural state. If the rotation center part is set above the uppermost part of the locking surface of the lock portion in the connected state of the first and second housings, rattling between the first and second housings can be suppressed even if a locked portion of the locking portion is perpendicularly arranged along the vertical direction.

### LIST OF REFERENCE NUMERALS

10 . . . first connector
11, 11A . . . first housing
12, 12A . . . terminal accommodating portion
13, 13A . . . fitting tube portion
14 . . . linking portion
15, 15A . . . cavity
16 . . . first terminal fitting
17 . . . bulging portion
18, 18A . . . wall portion
19, 19A . . . covering portion
21, 21A . . . front portion
22, 22A . . . rear portion
23, 23A . . . bent portion
24, 24A . . . releasing operation space
25, 25A . . . lock arm
26, 26A . . . extending portion
27, 27A . . . base portion
28, 28A . . . lock body portion
29 . . . releasing portion
32, 32A . . . locking portion
33 . . . inner extending portion
34, 34A . . . locked surface
35 . . . front inclined surface
60 . . . second connector
61, 61A . . . second housing
62 . . . receptacle (housing body)
63 . . . second terminal fitting
64 . . . back wall
65 . . . lock portion
66 . . . locking surface
67 . . . lock peak (uppermost part of locking surface of lock portion)
68 . . . guide portion
90 . . . wire
95 . . . rubber plug
96 . . . sealing ring
C1 . . . rotation center part
C2 . . . contact part

1. A connector, comprising a first housing and a second housing connectable to each other,
the second housing including a housing body and a lock portion projecting on an upper surface of the housing body,
the first housing including a base portion and a lock body portion extending from the base portion, the lock body portion being deflectable and deformable with the base portion as a fulcrum,
the lock portion having a locking surface facing in a direction opposite to a connection direction of the second housing to the first housing,
the lock body portion including a locking portion on a tip part in an extension direction from the base portion, the locking portion being arcuately displaced about a rotation center part on the base portion side, the locking portion facing and being lockable to the locking surface, and
the rotation center part being set above an uppermost part of the locking surface of the lock portion in a connected state of the first and second housings.

2. The connector of claim 1, wherein the locking portion has a locked surface inclined in a direction separating from the locking surface from a locking part for contacting a lowermost part of the locking surface of the lock portion toward an upper side in the connected state of the first and second housings.

3. The connector of claim 1, wherein:
the first housing includes an extending portion extending side by side with the lock body portion from the base portion and a wall portion coupled to a tip part of the extending portion in the extension direction from the base portion,
the extending portion is deflectable and deformable with the wall portion as a fulcrum, and
the base portion is displaceable in a vertical direction according to a deflection movement of the extending portion.

4. The connector of claim 3, wherein:
a pair of the extending portions and a pair of the wall portions are provided on both sides across the lock body portion, and
the pair of wall portions are arranged to cover the lock body portion from the both sides.

5. The connector of claim 4, wherein:
the pair of wall portions include front portions for covering the tip part of the lock body portion in the extension direction from the base portion, rear portions for covering the base portion from the both sides and bent portions extending in a direction separating from the lock body portion from the front portions to the rear portions,
a releasing operation space for releasing locking of the lock body portion with the lock portion is formed between a pair of the rear portions, and
tip parts of the extending portion in the extension direction from the base portion are coupled to the bent portions.
